(19) United States
(12) Patent Application Publication
(10) Pub. No.: US 2019/0085604 A1
(43) Pub. Date: Mar. 21, 2019

(54) ANIMAL CARRIER DOOR LATCH

(71) Applicant: Cabela's Incorporated, Sidney, NE (US)

(72) Inventors: Stephen Pearson, Sidney, NE (US); Ronald Nelson, Sidney, NE (US)

(21) Appl. No.: 15/709,991

(22) Filed: Sep. 20, 2017

(51) Int. Cl. E05C 9/04; E05C 1/00; E05C 1/06; E05C 19/06; E05C 9/22; A01K 5/01; A01K 1/02; A01K 1/03

(52) U.S. Cl. CPC E05C 9/048; E05C 1/004; E05C 1/06; E05C 19/06; A01K 5/0107; A01K 5/0135; A01K 1/0272; A01K 1/034; E05C 9/22

(57) ABSTRACT

A pet carrier and kennel which has an interior space for housing or storing animals. The interior space is fully enclosed on all sides by walls, a floor, and a roof to contain animals and related accessories such as blankets, beds, or bowls. The interior of the kennel can be accessed through an opening. A door is positioned in the opening to cover the opening. The door includes a locking mechanism that is easy to operate and can be opened from either side of the kennel.

### BACKGROUND

Many pet owners desire to carry their animals with them when they travel. This is especially true for sportsmen, who often bring animals such as trained dogs on hunting, camping, or other outdoor expeditions. Often pet owners do not want their animals to be loose in their vehicle during travel, and this may be especially true when travelling in a pick-up truck or similar open-air vehicle. Similarly, some pet owners may want a safe place for their animals where they may be contained, such as while at their home or a campsite. Animal kennels may serve this purpose.

Kennels, or pet carriers, currently come in a variety of shapes and configurations. Currently available mechanisms for opening the doors of kennels can be cumbersome or difficult to operate, requiring what may be excessive hand or finger strength and dexterity. Additionally, the door may not be configurable for optimal use across a variety of situations or environments. There is a need for a more versatile kennel that has a door locking mechanism that is easy to operate, with a door that can be opened from either side of the kennel.

### SUMMARY

The present disclosure is containment structure for animals, comprising an enclosure formed by a floor, a front wall, a back wall, a first side wall, a second side wall, and a roof enclosing an interior space. The front wall includes an aperture providing access to the interior space. The aperture is defined by a flange extending outward from the front wall, the flange including first and second openings. A door sized to fit within the aperture and configured to restrict access to and from the interior space through the aperture has support members defining a vertical channel. A pull handle is disposed within the vertical channel, and includes a first rigid pin disposed within the vertical channel. The first rigid pin is configured to slide into the first opening of the flange when the door is within the aperture. A second rigid pin is disposed within the vertical channel. The second rigid pin is configured to slide into the second opening of the flange when the door is within the aperture.

A flexible member disposed within the vertical channel of the door is coupled to the first rigid pin and the second rigid pin so that when the flexible member is pulled away from the door the first rigid pin and the second rigid pin are pulled towards one another.

A containment structure for animals comprising an enclosure formed by a floor, a front wall, a back wall, a first side wall, a second side wall, and a roof enclosing an interior space. The front wall includes an aperture providing access to the interior space, the aperture being defined by a flange extending outward from the front wall and including first, second, third, and fourth openings. A door is sized to fit within the aperture and configured to restrict access to and from the interior space through the aperture. The door has support members defining a first and second vertical channel. A first pull handle is disposed within the first vertical channel, and includes a first rigid pin disposed within the first vertical channel. The first rigid pin is configured to slide into the first opening of the flange when the door is within the aperture. A second rigid pin is disposed within the first vertical channel and configured to slide into the second opening of the flange when the door is within the aperture. A flexible member is coupled to the first rigid pin and the second rigid pin so that when the flexible member is pulled away from the door the first rigid pin and the second rigid pin are pulled towards one another. A second pull handle is disposed within the second vertical channel and includes a third rigid pin disposed within the second vertical channel. The first rigid pin is configured to slide into the third opening of the flange when the door is within the aperture. A fourth rigid pin is disposed within the second vertical channel. The second rigid pin is configured to slide into the fourth opening of the flange when the door is within the aperture. A second flexible member is coupled to the third rigid pin and the fourth rigid pin so that when the flexible member is pulled away from the door the third rigid pin and the fourth rigid pin are pulled towards one another.

A device, comprising a door frame with first and second openings, a door sized to fit within the perimeter of the door frame, and configured to restrict access to and from the interior space through the aperture. The door has support members defining a vertical channel and a pull handle disposed in the vertical channel. The pull handle includes a first rigid pin disposed within the vertical channel. The first rigid pin is configured to slide into the first opening of the flange when the door is within the aperture. A second rigid pin is disposed within the vertical channel, the second rigid pin being configured to slide into the second opening of the flange when the door is within the aperture. A flexible member is coupled to the first rigid pin and the second rigid pin so that when the flexible member is pulled away from the door the first rigid pin and the second rigid pin are pulled towards one another.

### BRIEF DESCRIPTION OF DRAWINGS

The detailed description is set forth with reference to the accompanying figures. The use of the same reference numbers in different figures indicates similar or identical items or features.

FIG. 1 illustrates a 3D perspective view of a kennel

FIG. 2A illustrates a perspective view of the front and side of a kennel.

FIG. 2B depicts a detail cross-section view of a portion of FIG. 2A showing a nesting location according to one embodiment.

FIG. 3A illustrates a front view of a kennel.

FIG. 3B depicts a detailed cross-section view of a portion of a nesting location as depicted in FIG. 3A.

FIG. 3C illustrates an example pull handle mechanism as depicted in FIG. 3A.

FIG. 4A illustrates a top-down view of the front and side of a kennel.

FIG. 4B illustrates a detail view of a portion of FIG. 4B.

FIG. 4C illustrates a bottom-up view of the front and side of a kennel.

FIG. 4D illustrates a detail view of a portion of FIG. 4C.

FIG. 5 illustrates a cot that may be integrated with one embodiment of a kennel.

FIG. 6 illustrates a bowl that may be removably attached to an embodiment of a kennel.

### DETAILED DESCRIPTION

Kennels are commonly used by pet owners for the housing and transport of animals. Kennels may be used within a home or yard as a place where animals may seek shelter or comfort, such as during a storm or when the animal is experiencing stressful external stimuli. Additionally, kennels also provide a space for the animal to sleep or rest. In many cases, kennels are used to create a personal space for the animals and may be equipped with blankets, pillows, or other suitable material to enhance the comfort of the space. Kennels may also be equipped with food and/or water bowls for the animal. This is especially true when pet owners travel with their animals. The kennels may serve as the physical housing for the animals during transport, containing the animals within a larger vehicle.

In a particular example, sportsmen may travel to the wilderness for hunting or fishing trips with sport or companion animals. Often, rugged vehicles such as pick-up trucks, sport utility vehicles, all-terrain vehicles, or other similar vehicles may be used as transportation, particularly in off-highway situations. In these instances the fully enclosed nature of the kennel make them ideal for containing animals and related accessories such as blankets or bowls in otherwise open-air cargo or storage areas of the vehicles. Kennels may also prevent the animal from being loose or restless within the cargo area or cabin of the vehicle, and potentially interfering with its operation. In addition to an animal, pet owners may also transport clothing, personal items, or other gear as needed, particularly for outdoor trips such as hunting or fishing. A kennel may protect an animal from cargo shifting within the vehicle during travel.

Once at a final destination, the kennels may provide a place for the animal to reside or seek refuge. For sportsmen this may be at a campsite, lodge, or similar, whereas for other pet-owner travelers this could be at a hotel, private residence, or other similar location. In either scenario, a kennel may provide a pet owner with a convenient place to store and care for the needs of animals. This may include sleeping, eating, and drinking areas, wherein a kennel essentially becomes a home for the animal for at least a period of time, and so must be comfortable and easy to use for both an animal and pet owner.

A kennel must therefore make efficient use of space, have a door or gate that can be securely fastened to create an enclosed, rigid containment structure, and have features that make it simple to move and operate. Additionally, the use of kennels across a wide variety of activities and environments necessitates a versatile functionality that can be easily utilized. The ability to open a kennel from either the left or right side with a simple pulling mechanism would solve these needs.

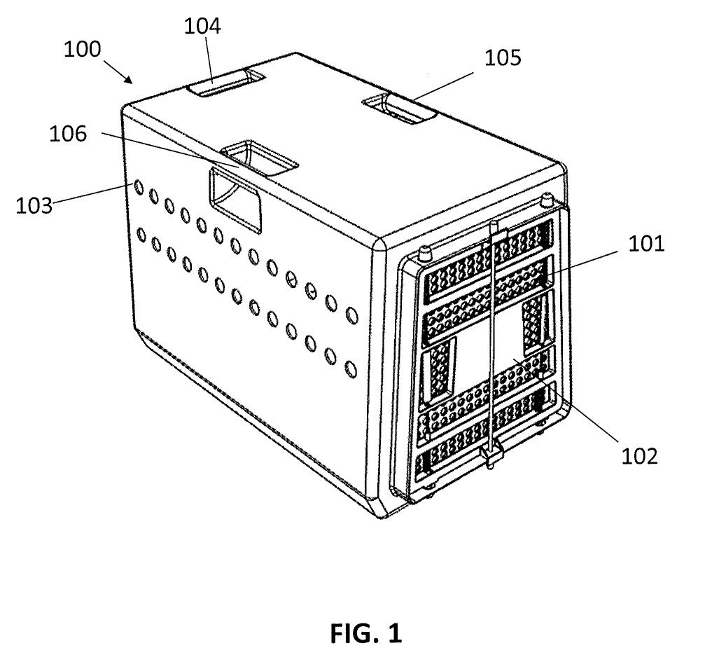

In general, kennel designs may use a number of structural panels or walls arranged to create a fully enclosed space where animals may be contained. Top, bottom, rear, and side walls or panels typically comprise a kennel, with at least an opening in the front where an animal may enter and exit. A gate or door that securely closes may be used to cover the opening in the front of the kennel to fully enclose the interior space and contain an animal therein. FIG. 1 illustrates a perspective view of an example embodiment of the dog kennel system of the present invention.

The dog kennel system 100 depicted here is an enclosure that has a hollow rectangular cuboid shape with bottom, top, sides, front, and rear panels formed from a single roto-mold. An aperture 101 on the front panel of the kennel system provides an opening where animals can enter or exit the kennel, with a door 102 that can be securely closed. Side panels of the kennel feature perforations 103 to provide ventilation to the interior containment space. Perforations 103 are sized and spaced along the side panels so as to allow fresh air or small objects such as food or treats to be passed through without compromising the containment functionality of the kennel.

Transport handles 104, 105, 106 are integrated into the kennel structure along the vertices between the horizontal top panel and each of the side and rear panels that make up the walls of the kennel. These handles are formed within the contours of the structure such that they do not extend beyond the height, width, or length of the kennel as defined by the planar surfaces of the top or side panels. This design maintains the cuboidal geometry and preserves the streamlined contours of the kennel for efficient use of space and no obtrusions to interfere with other cargo in a transport vehicle. Recessions formed from an inversion of the vertex in the top and side panels create enough relief space to enable grabbing the handles for carrying. Alternatively, the recessions create space for straps, rope, or other fasteners to pass through so as to attach to the handles. This allows the kennel to be secured during transport, such as in the bed of a pickup truck. Alternatively, a plurality of kennels may be coupled together using the handles as an anchor.

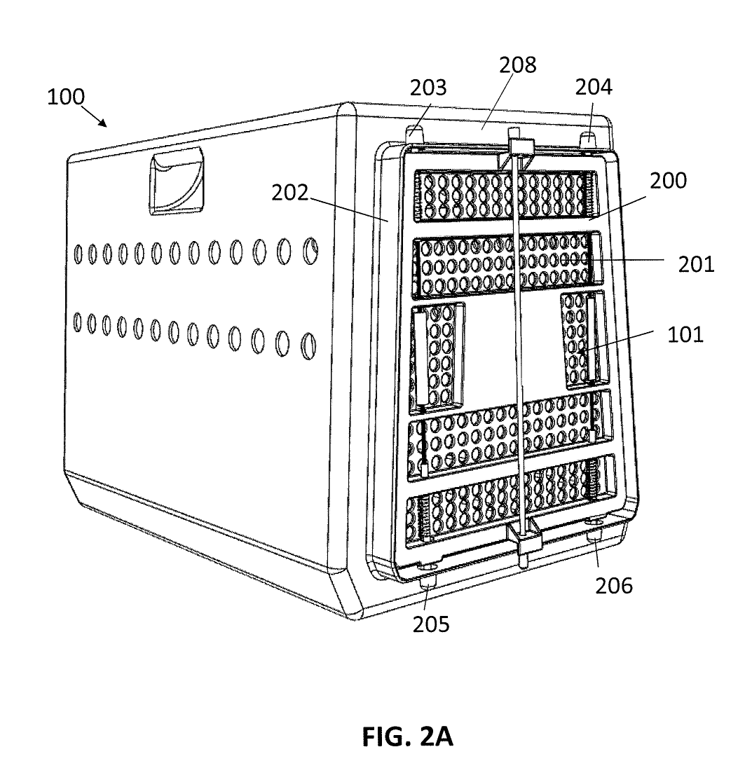

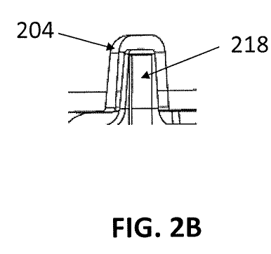

Access to the interior space of the kennel is provided by aperture 101 in the front wall of the kennel. FIG. 2 is a perspective view of dog kennel system 100 showing additional detail of aperture 101. As seen in FIG. 2, a hinged door 200 in the shape of aperture 101 is positioned to secure the kennel. Door 200 includes a plurality of small openings 201 throughout its planar face to provide ventilation to an animal in the kennel, as well as a means for viewing the interior of the kennel while the door is closed. A lip 202 (also referred to herein as a flange) is formed in the front face 208 of kennel system 100 and extends a short distance perpendicularly from the front face 208 of the kennel around the perimeter of the kennel aperture 101 and serves as a frame for door 200. Door 200 is disposed inside the door frame created by lip 202. There are four nesting locations 203,204,205,206 located on lip 202 of aperture 101; two nesting locations 203, 204 extending upward toward the top of the kennel from the upper surface of lip 202 and two nesting location 205, 206 extending downward from the bottom surface of lip 202. These nesting locations 203,204,205,206 may be hollow cylindrical or conical shapes that open to the interior of the door frame to form recessed areas. Each nesting location 203,204,205,206 may be positioned near a corner on the side of the kennel opening. FIG. 2B is a cross-sectional view of a nesting location (e.g., nesting location 204) showing recessed area 218. These features will be described in more detail below.

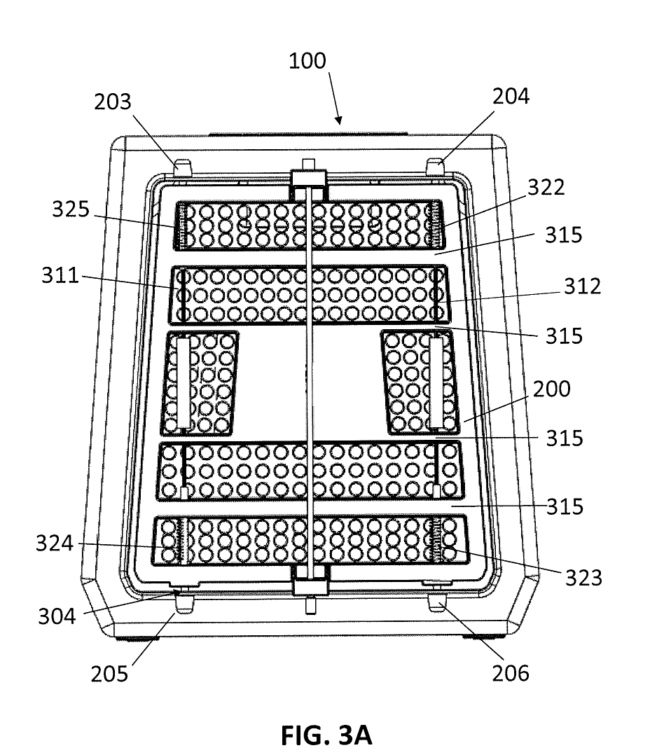

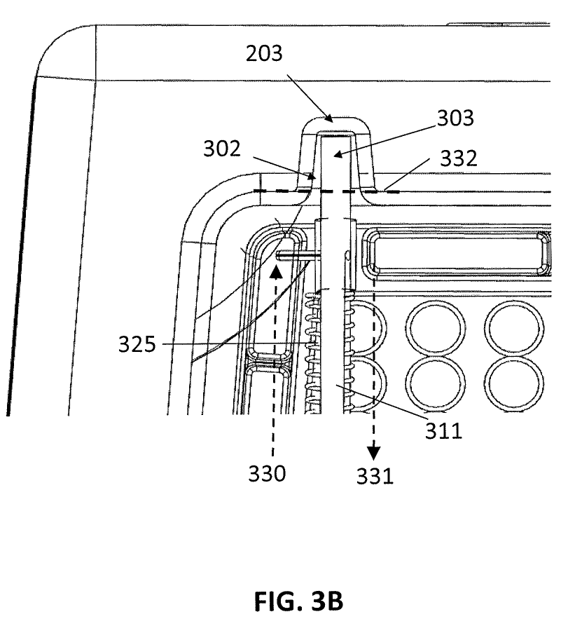

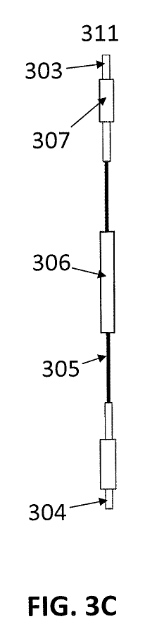

Door 200 may be secured to the kennel with a latching mechanism. FIG. 3A shows a front view of kennel 100 with a latching mechanism comprised of pull handle mechanism 311, 312, compression springs 322, 323, 324, 325, and nesting locations 203, 204, 205, 206. A system of rigid pins that are attached to the exterior of the door serve as detent members to secure door 200 in the closed position. Each rigid pin consists of portion of material sized to fit into a recessed area of a nesting location 203,204,205,206. FIG. 3B depicts a cross sectional view of nesting location 203, depicting recessed area 302, and rigid pin 303 sized to fit into the recessed area 302. FIG. 3C depicts a detailed view of pull handle mechanism 311 with an upper 303 and lower 304 rigid pin. Pull handle mechanism 312 may be similarly configure to pull handle mechanism 311. Each rigid pin 303, 304 consists of portion of material sized to fit into a recessed area of a nesting location, and another portion 307 with a larger radius that creates a distended portion in the pin. Rigid pin 303 is coupled with rigid pin 304 by a connecting member 305 to form pull handle mechanism 311.

In one embodiment there may be a foam, plastic, rubber, or other suitable material positioned concentrically around at least a portion of the pull handle mechanism 311 and extending bilaterally from the midpoint of the pull handle mechanism 311 for some distance to form a grip 306 for a user. A connecting member 305 may be a length of cable, rope, or other flexible material or other type of flexible member with tensile properties that extends from upper rigid pin 303 to lower rigid pin 304. Each upper and lower rigid pin is concentrically aligned with a corresponding upper 203 or lower 205 nesting location in the door frame. A series of support members or ribs 315 run horizontally across the face of the kennel door. Each rib has two holes that concentrically align with the nesting locations in the door frame, and create a channel within which a pair of pull handle mechanisms 311, 312 run vertically along the face of the kennel door, wherein pull handle 312 is similarly configured to pull handle 311. The length of each pull handle mechanism is greater than the height of the door, such that when the door is in the closed position the rigid pins extend upward or downward, respectively, through the door frame and into a detent recessed area at the nesting locations. The door is secured in the closed position by a plurality of coil springs 322, 323, 324, 325 that hold each pull handle mechanism in tension. A spring is positioned concentrically around each rigid pin, exerting tensile force on a surface of distended portion 307 of a rigid pin and on a surface of a horizontal rib 315 on the face of the kennel door. The tensile force of each spring on its respective rigid pin that provides a bias that holds the pins in the nesting location, securing the door closed.

In the closed position, each pull handle mechanism serves as a latching system to keep the kennel door secure. The door may be opened from either the right or left side, with one pull handle mechanism serving as a latch release mechanism and the other pull handle mechanism serving as a hinge member. The kennel door is opened by pulling on a first pull handle mechanism in a generally perpendicular direction relative to the planar surface of the kennel door. When a user applies a pulling force on the handle, a flexible portion of the pull handle mechanism extends outward. A channel formed in the horizontal ribs constrains the movement of the pull handle mechanism and translates a horizontal pulling force on a handle to a vertically aligned force that draws the rigid pins out of the detent recess of their respective nesting location, compressing the springs and freeing the door to open. This process is depicted for a single nesting location 203 in FIG. 3B, where rigid pin 303 is held in recessed area 302 by a force aligned with direction 330 from spring 325. As the pull handle mechanism 311 moves away from the front face of the kennel, rigid pin 303 moves in a direction aligned with arrow 331, compressing spring 325. When the distal end of rigid pin 303 clears the opening of nesting location 203, demarcated by line 332, the rigid pin 303 is no longer contained in recessed area 302. Referring now to FIG. 3A, a mirror image of this process occurs simultaneously at the opposite distal end of pull handle mechanism 311, with rigid pin 304 being withdrawn from nesting location 205. Springs hold the second pull handle mechanism 312 in tension and the upper and lower detent rigid pins remain in their respective nesting location in the door frame. The second pull handle mechanism 312 acts as a hinging mechanism where the door rotates open around the second pull handle mechanism. Once the rigid pins have cleared the detent recess and the door is free to open, tension on the handle may be released, allowing the coil springs to decompress and pull handle mechanism to extend to full length. In this system it may be possible to open the door from either side using a simple pulling motion. Alternatively, the door may be fully removed from the kennel by pulling on both pull handle mechanisms.

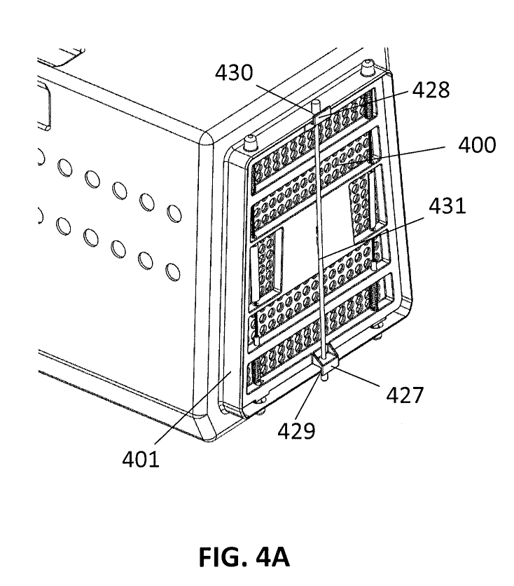

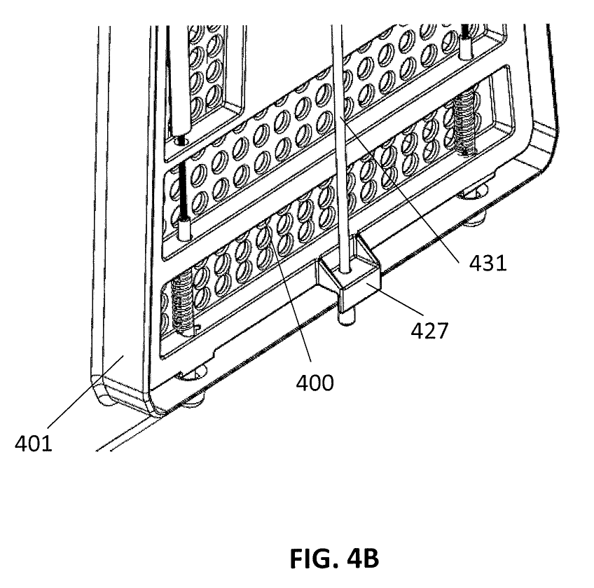

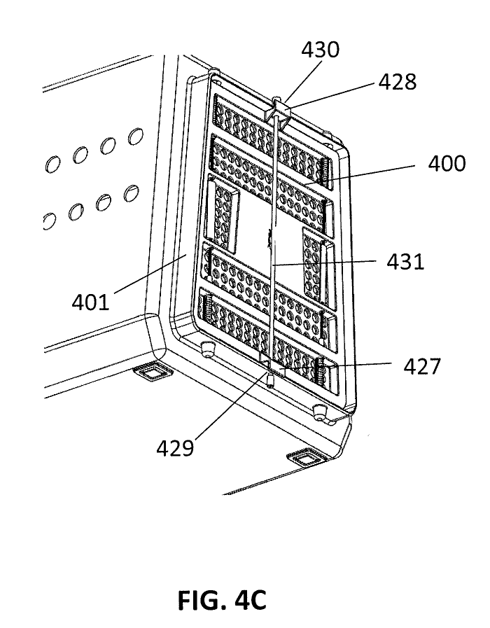

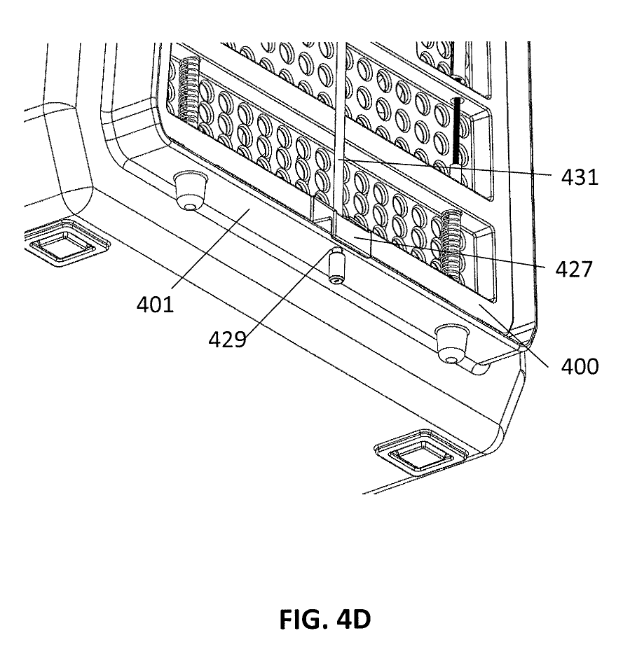

The door may be further secured using a locking mechanism. FIG. 4A depicts an embodiment of a kennel door 400 from a downward facing perspective. Kennel door 400 may be configured similarly to kennel door 200 depicted in FIGS. 2 and 3 except for differences described below. Formed tabs 427, 428 positioned on the front face of the door interface with the door frame to accommodate additional locking mechanism. FIG. 4b depicts a detailed view of a lower portion of a door and including tab 427. A detail view of tab 428 is not depicted, but tab 428 may be similarly configured to tab 427, but oriented upside down. Each of the tabs 427, 428 may include holes that concentrically align with holes 429, 430 in the door frame 401 of the kennel. FIG. 4C depicts an upward facing perspective of the kennel door 400 showing the underside of the door frame 401. FIG. 4D is a detailed view of FIG. 4C, which more clearly illustrates a concentric alignment of hole 429 in door frame 401 and a hole in tab 427. In one embodiment a center lock bar 431 may pass through the holes 429, 430 in door frame 401 and in tabs 427, 428 in order to prevent the door from being opened. Other similar devices such as a padlock, cotter pin, or similar may be used to secure the door by passing through either or both tabs 427, 428, and their adjacent holes 429, 430 of door frame 401. A locking mechanism may provide additional measures to keep a kennel door closed should a pull handle mechanism be accidentally delatched.

Other alterations and modifications of the present invention will likewise become apparent to those of ordinary skill in the art upon reading the present disclosure. It is intended that the scope of the invention disclosed herein be limited only by the broadest interpretation of the appended claims to which the inventors are legally entitled.

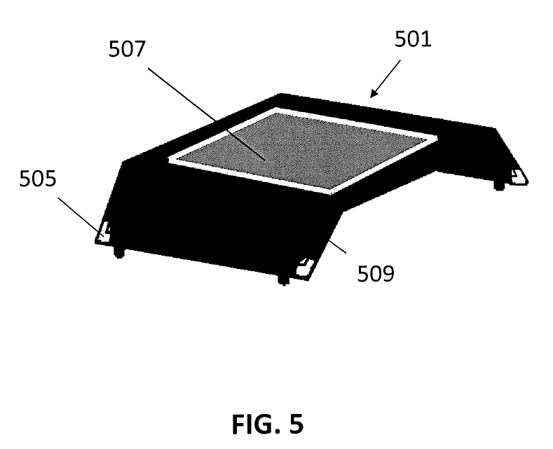

Within the enclosed containment space, the kennel may include an integrated cot system. FIG. 5 is an example embodiment of cot system 501. A tubular rectangular frame 505 formed from aluminum or similar material may be used to support a self-draining fabric material 507, such as duramesh or similar, to form a cot bed. Together, frame 505 and self-draining fabric material 507 form a raised platform that may be positioned within the kennel system and sized to fill the floor space of the kennel. The rectangular bed material may have channels sewn along each edge through which the frame rails may be inserted, and may suspend the bed material through tension when the frame is fully assembled. Angled leg portions 509 of the frame may be used to raise a portion of the cot system to a height above and parallel to the floor of the kennel. Any fluid, such as animal waste or drinking water, may drain through the cot material into the space between the cot bed and the floor of the kennel, leaving a dry area above for the animal to reside. The cot system may be removed from the kennel for cleaning, or used by the animal independent of the kennel, such as in the home.

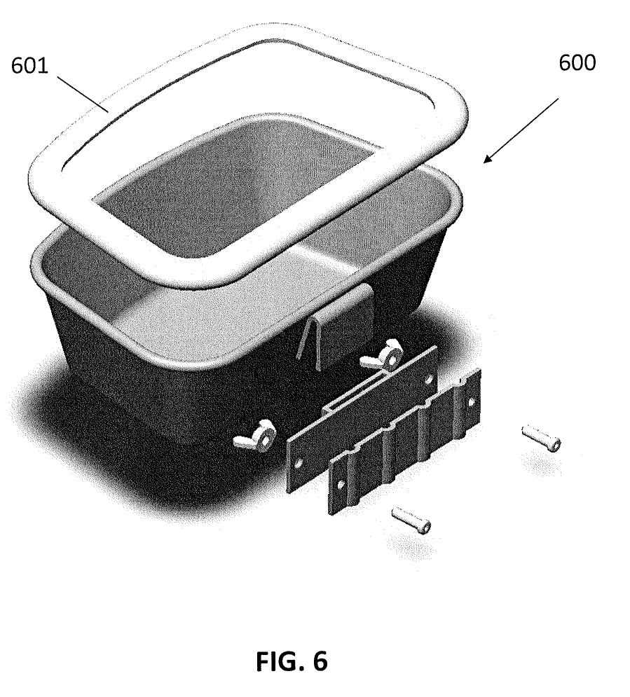

The kennel may serve as an area where the animal eats or drinks, and as such may be used to house serving bowls. A number of features are used in order to mitigate the possibility of spilling food or water within the kennel. FIG. 6 illustrates a removable bowl 600, to be used for food or water that may include a lip 601 that extends around the top of the bowl and provides an overhang that protrudes into the interior of the bowl. The lip acts as a partial lid to the bowl, which may prevent spillage of the contents in the event the bowl is disturbed, such as by the animal bumping it during entry/exit, movement of the kennel during transport or loading/unloading of the transport vehicle, or other potential disturbances. The bowl may be further secured within the kennel to keep it in place.

Reference throughout this specification to “one embodiment,” “an embodiment,” “one implementation,” or “an implementation” may mean that a particular feature, structure, or characteristic described in connection with a particular embodiment or implementation may be included in at least one embodiment or implementation of claimed subject matter. Thus, appearances of the phrase “in one embodiment,” “an embodiment,” “one implementation,” or “an implementation” in various places throughout this specification are not necessarily intended to refer to the same embodiment or implementation, or to any one particular embodiment or implementation described. Furthermore, it is to be understood that particular features, structures, or characteristics described may be combined in various ways in one or more embodiments or implementations. In general, of course, these and other issues may vary with the particular context of usage. Therefore, the particular context of the description or the usage of these terms may provide helpful guidance regarding inferences to be drawn for that context.

What is claimed is:

1. A containment structure for animals, comprising:
an enclosure formed by a floor, a front wall, a back wall, a first side wall, a second side wall, and a roof enclosing an interior space, wherein the front wall includes an aperture providing access to the interior space, the aperture being defined by a flange extending outward from the front wall, the flange including first and second openings;
a door sized to fit within the aperture, the door being configured to restrict access to and from the interior space through the aperture, the door having support members defining a vertical channel; and
a pull handle disposed within the vertical channel, the pull handle including:
a first rigid pin disposed within the vertical channel, the first rigid pin being configured to slide into the first opening of the flange when the door is within the aperture;
a second rigid pin disposed within the vertical channel, the second rigid pin being configured to slide into the second opening of the flange when the door is within the aperture;
a flexible member disposed within the vertical channel of the door, the flexible member being coupled to the first rigid pin and the second rigid pin so that when the flexible member is pulled away from the door the first rigid pin and the second rigid pin are pulled towards one another.

2. The containment structure of claim 2, further comprising:
a first spring concentrically mounted about the first rigid pin to bias the first rigid pin in a first direction; and
a second spring concentrically mounted about the second rigid pin to bias the second rigid pin in a second direction opposite the first direction.

3. The containment structure of claim 1, wherein the first vertical channel is located on a first lateral portion of the door and the second vertical channel is located on a second lateral portion of the door.

4. The containment structure of claim 1, wherein the flange includes an additional opening configured to receive a locking mechanism.

5. The containment structure of claim 1, further comprising a raised platform disposed within the interior space, the platform having openings for fluid drainage.

6. The containment structure of claim 1, further comprising a spill-resistant bowl removably attached to the door.

7. The containment structure of claim 1, wherein a vertex between a side wall and the roof includes an integrated transport handle.

8. The containment structure of claim 1, wherein the pull handles include a grip concentrically positioned around the flexible member.

9. A containment structure for animals, comprising:
an enclosure formed by a floor, a front wall, a back wall, a first side wall, a second side wall, and a roof enclosing an interior space, wherein the front wall includes an aperture providing access to the interior space, the aperture being defined by a flange extending outward from the front wall, the flange including first, second, third, and fourth openings;
a door sized to fit within the aperture, the door being configured to restrict access to and from the interior space through the aperture, the door having support members defining a first and second vertical channel;
a first pull handle disposed within the first vertical channel, the first pull handle including:
a first rigid pin disposed within the first vertical channel, the first rigid pin being configured to slide into the first opening of the flange when the door is within the aperture;
a second rigid pin disposed within the first vertical channel, the second rigid pin being configured to slide into the second opening of the flange when the door is within the aperture;
a flexible member coupled to the first rigid pin and the second rigid pin so that when the flexible member is pulled away from the door the first rigid pin and the second rigid pin are pulled towards one another; and
a second pull handle disposed within the second vertical channel, the second pull handle including:
a third rigid pin disposed within the second vertical channel, the first rigid pin being configured to slide into the third opening of the flange when the door is within the aperture;
a fourth rigid pin disposed within the second vertical channel, the second rigid pin being configured to slide into the fourth opening of the flange when the door is within the aperture;
a second flexible member coupled to the third rigid pin and the fourth rigid pin so that when the flexible member is pulled away from the door the third rigid pin and the fourth rigid pin are pulled towards one another.

10. The containment structure of claim 9, further comprising:
a first spring concentrically mounted about the first rigid pin to bias the first rigid pin in a first direction; and
a second spring concentrically mounted about the second rigid pin to bias the second rigid pin in a second direction opposite the first direction.

11. The containment structure of claim 9, wherein the first vertical channel is located on a first lateral portion of the door and the second vertical channel is located on a second lateral portion of the door.

12. The containment structure of claim 9, wherein the flange includes an additional opening configured to receive a locking mechanism.

13. The containment structure of claim 9, further comprising a raised platform disposed within the interior space, the platform including a self-draining fabric.

14. The containment structure of claim 9, further comprising a spill-resistant bowl removably attached to the door.

15. The containment structure of claim 9, wherein a vertex between a side wall and the roof includes an integrated transport handle.

16. The containment structure of claim 9, wherein the pull handles include a grip concentrically positioned around the flexible member.

17. A device, comprising:
a door frame with first and second openings;
a door sized to fit within the perimeter of the door frame, the door being configured to restrict access to and from the interior space through the aperture, the door having support members defining a vertical channel; and
a pull handle disposed in the vertical channel, the pull handle including:
a first rigid pin disposed within the vertical channel, the first rigid pin being configured to slide into the first opening of the flange when the door is within the aperture;
a second rigid pin disposed within the vertical channel, the second rigid pin being configured to slide into the second opening of the flange when the door is within the aperture;
a flexible member coupled to the first rigid pin and the second rigid pin so that when the flexible member is pulled away from the door the first rigid pin and the second rigid pin are pulled towards one another.

18. The device of claim 17, further comprising:
a first spring concentrically mounted about the first rigid pin to bias the first rigid pin in a first direction; and
a second spring concentrically mounted about the second rigid pin to bias the second rigid pin in a second direction opposite the first direction.
